(19) United States
(12) Patent Application Publication
(10) Pub. No.: US 2003/0095188 A1
(43) Pub. Date: May 22, 2003

(54) Method and apparatus for adjusting image distortion

(76) Inventors: Yau-Liang Tsai, Hsin Tien City (TW); Nai-Yueh Liang, Hsin Tien City (TW); Li-Kuo Liu, Hsin Tien City (TW); George J. Yang, Hsin Tien City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/143,938

(22) Filed: May 14, 2002

(30) Foreign Application Priority Data
Nov. 21, 2001 (TW) 090128814

(51) Int. Cl. H04N 5/225

(52) U.S. Cl. 348/207.1

(57) ABSTRACT

A method and apparatus for adjusting image distortion is disclosed. In the adjustment process: a test pattern image is first output to a display device; the test pattern image appearing on the screen of the display device is captured by a image-capturing device; the image signal is output to a computer to calculate the distortion factor in relation to a display device, based on which a compensation factor is derived from its inverse relation; and the compensation factor is added to the actual image signal and output to the display device. The image output on the screen of the display will be a distortion-free image, due to the canceling of the deflection tendency on the display device by the compensated image signals.

### BACKGROUND OF THE INVENTION

1. Field of the Invention

The present invention relates to a method and apparatus for adjusting the image distortion in connection with a display device. The method is basically accomplished through a sequence of steps from displaying a first image on a display device, capturing the first image being displayed, calculating the distortion factor for the display device, calculating a compensation factor based on the distortion factor and compensating a second image to be displayed. The first image is a test pattern to check the display characteristics of the deflection-disposed display device. The second image is the actual image made to appear on the screen of the deflection-disposed display device without distortion. In the image transformation process, the distortion factor and compensation factor will tend to offset each other.

2. Description of Related Art

In general, image display devices can be separated into two main classes based on the display technology: the direct view type and the projector type. More commonly used display devices include cathode ray tube (CRT), liquid crystal display (LCD), digital light processing (DLP) and liquid crystal on silicon (LCoS). Image distortion can occur with any type of display devices. For a CRT display, electrons are emitted from an electron emitting tube to a display screen. When the electron beam strikes the display screen, an image is produced. Consequently, with appropriate adjustment of the electron beam focused on the display screen to produce a good electron landing position, the image quality of the display can be greatly improved.

However, an electron beam is susceptible to electromagnetic interference from the surrounding environment. If an electron beam is deflected by outside interference, image distortion will appear on the display screen. According to the conventional technique, a deflection correction circuit is installed in the display device to counter the effect of electron beam deflection. The effect of electric or magnetic fields on the electron beam can be modified through the synchronized action of various components in the deflection correction circuit. Since most of the components employed in this correction circuit are non-linear, repeated micro-adjustments are required to attain the desired result. Therefore, this type of operation, technically speaking, is more difficult than the method in the present invention.

Although a projector type display never encounters electron beam deflection, their problem is that the relative distance between the RGB (red, green and blue) color separation panels and the lens may move out of focus. Since three color beams cannot be superposed correctly, image blurring and distortion are some of the problem phenomena. The lens itself could also cause problems like chromatic dispersion and defocusing. The current technique to solve the foregoing problems on a projector type display is through precision adjustment of the mechanical structure of the display. However, the procurement of precision equipment and mechanical tools entails high costs.

It is apparent that the foregoing adjustment technique cannot be universally applied on all types of displays without modification. All sorts of distortion can develop on a display device, whether it be a direct view type or projector type. The precision adjustment technique is a hardware-specific solution. It will be increasingly difficulty to cope with all sorts of image distortion and display hardware, considering the high precision and high costs for such mechanical tools.

To overcome the conventional design flaws, the present invention provides a method and apparatus for adjusting image distortion based on a pre-compensation on the image signal input, without having to change the original circuit design. This method can be equally effective for correction of any type of geometric image distortions.

### SUMMARY OF THE INVENTION

The main objective of the present invention is to provide a method and apparatus for adjusting image distortion, which is mainly accomplished through a sequence of steps: (a) outputting a first image from a computer, (b) displaying the first image on a display device, (c) capturing the first image displayed on the display device by an image-capturing device, (d) calculating the distortion factor of the display device by a computer, (e) calculating the compensation factor based on the distortion factor using the computer, (f) compensating a second image with the compensation factor, and (g) displaying the compensated image on the display device. The first image is a test pattern for the calculation of the distortion factor of the display device, and the second image is the actual image to be displayed. In that the distortion factor and the compensation factor offset each other in the image transformation, the second image will be output distortion free on the deflection-disposed display device.

The features and related techniques of the present invention will emerge more clearly from the description of the preferred embodiment in conjunction with the figures of the invention.

### BRIEF DESCRIPTION OF THE DRAWINGS

FIG. 1 is a block diagram of an image distortion adjusting apparatus in accordance with the present invention;

FIG. 2 is a test pattern;

FIG. 3 is a distorted image of the test pattern in FIG. 2;

FIG. 4 is another distorted image of the test pattern in FIG. 2; and

FIG. 5 is a procedural diagram of the image adjustment method proposed in the present invention.

### DETAILED DESCRIPTION OF THE PREFERRED EMBODIMENT

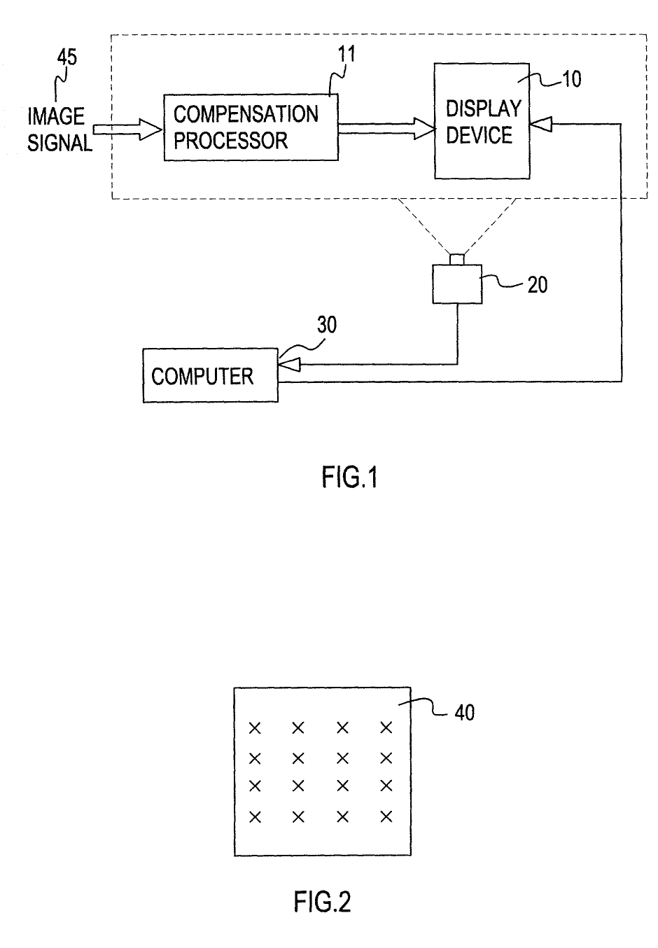

With reference to FIG. 1, the apparatus for adjusting the image distortion in connection with a display device in accordance with the present invention includes a display device (10) that is equipped with an internal compensation processor (11), an image-capturing device (20) and a computer (30). The image-capturing device (20) is mounted in front of the display device (10) and focuses on the display device. The computer (30) is connected to the image-capturing device (20), the compensation processor (11) and the image-capturing device (20).

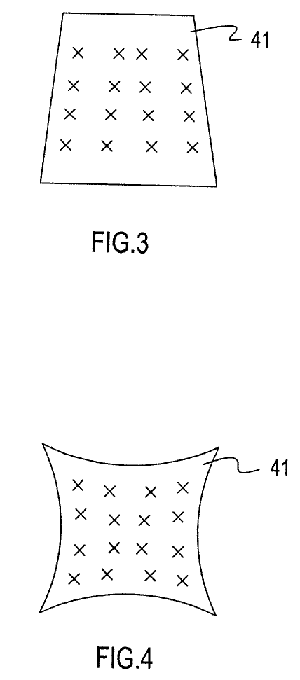

With reference to FIGS. 1 and 2, a test pattern image (40) is initially output from the computer (30) to the display device (10). All display parameters of the test pattern image (40), such as the pixel position and color value of each pixel of the test pattern image (40), are saved in the computer (30) before the image compensation begins. When the test pattern image (40) is output to the display device (10), a distorted pattern image (41) (shown in FIGS. 3 and 4) will appear on the screen of the display device (10). The distortion on the screen of the display device (10) could be image deflection, defocusing or a variety of other possible reasons caused by the display device (10).

The image of the distorted pattern (41) is then captured by the image-capturing device (20) focusing on the screen of the display device (10). The captured image is then input to the computer (30). Then the image of distorted pattern (41) and the test pattern image (40) are compared with each other to calculate a distortion factor for the display device (10). The image-capturing device (20) can be a camera. After the distortion factor of the display device (10) is obtained, a compensation factor derived from inverse computing of the distortion factor is calculated by the computer (30), and the compensation factor is written to the compensation processor (11). The distortion factor could be deemed as an image transforming function (f), and the compensation factor could be deemed as an inverse function (f¹) of the image transforming function. An image signal to be displayed (45) is made to pass through the compensation processor (11) before appearing on the screen.

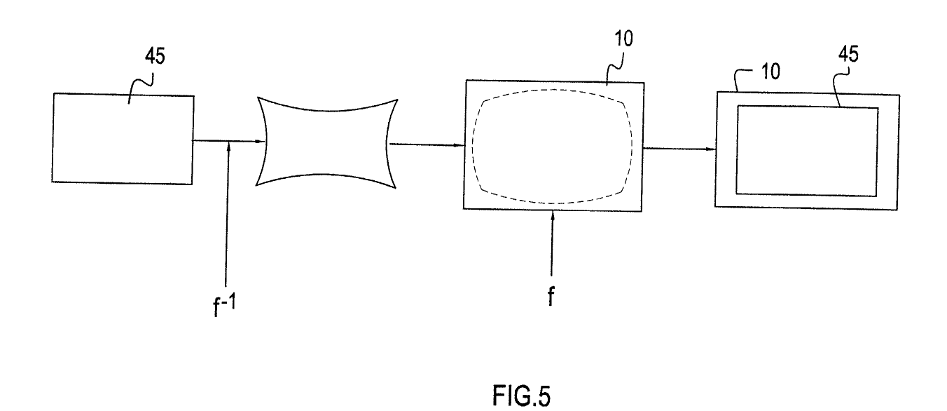

With reference to FIG. 5, the image signal to be displayed (45) is input to the compensation processor (11), in which a compensation factor (f¹) will be applied to the image to be displayed (45) in the first image transformation process. When the transformed image signal (45) is output to the display device (10), it undergoes another transformation process. Considering the effect of distortion factor (f) and compensation factor (f¹) being offset by each other, the image will be output on the display device (10) biased with a distortion factor (f). The image pattern will be restored to the original shape without distortion.

To illustrate the adjustment process more clearly, the image signal (45) is assumed to represent a rectangular pattern. The display device (10) biased with distortion factor (f) will cause the rectangle pattern to be inflated with lines curving outward, whereas the compensation factor (f¹) derived from inverse function of the distortion factor (f) will have a tendency to deflate the image. When the compensation factor (f¹) is added to the image signal (45), it will cause the image to contract. The compensated image signal is input to the display device (10) biased with a distortion factor (f) in which a second transformation of the image will allow the distortion factor (f) and the compensation factor (f¹) to offset each other. The image signal is output by the display device (10) recreating the original rectangular pattern.

From the technique of image adjustment described above, it is apparent that the front-end compensation of image signals is more advantageous for the following reasons:

Reduced complexity: Since the distortion adjustment can be done by means of front-end compensation rather than hardware modification of the original circuit, the complexity involved in the adjustment process is greatly reduced.

One-time operation: Since the initial task is to obtain a quantifiable distortion factor, which causes the image output of a geometrical pattern on a particular display device to be transformed, a compensation factor is then derived from the inverse function of the distortion factor. The next task is to add the compensation factor to an image signal. The final task is to output the image signal to the display device. The adjustment for image distortion proposed by the present invention only requires one cycle through the above-mentioned tasks, whereas hardware modification using an extra correction circuit and components requires repeated efforts to adjust the components to yield the best result.

Simplified circuit: The core of the present invention is a processor, whereas the correction circuitry involves a large number of components, thus the component count can be reduced, and so is the cost.

Enhanced precision: The adjustment proposed in the present invention uses a digital approach, whereas the conventional method uses an analog approach to adjust the circuit components. Therefore the precision level can be enhanced, resulting in better image quality.

Wide applications: It is possible to adjust any image distortion caused by display hardware, using the adjustment method proposed in the present invention.

The preferred embodiment of the present invention is intended to be illustrative only, and under no circumstances should the scope of the present invention be so restricted. In view of the advantages mentioned above, it is obviously more superior to the conventional method.

What is claimed is:

1. An adjustment apparatus for image distortion comprising:
a display device with an internal compensation processor;
an image-capturing device installed in front of the display device to capture the pattern displayed on the display screen;
a computer connected to the image-capturing device, through which a test pattern image is output to the display device; the test pattern image captured by the image-capturing device is read; a distortion factor is calculated by comparing the original test pattern image and the test pattern image captured; a compensation factor is derived from inverse function of the compensation factor; and finally the compensation factor is written to the compensation processor;
wherein the compensation processor receiving an image signal performs a front-end operation of adding the compensation factor to the image signal, and then outputting the compensated image signal to the display device.

2. The adjustment apparatus as claimed in claim 1, wherein the image-capturing device is a camera.

3. A method of adjusting image distortion comprising the steps of:
outputting a test pattern image to a display device;
capturing the distorted pattern image appearing on a screen of the display device;
comparing the test pattern image and the distorted pattern image to calculate a distortion factor;
calculating a compensation factor based on the distortion factor;
adding the compensation factor to an image signal; and
outputting the compensated image signal on the screen of the display device.

4. The method of adjusting image distortion as claimed in claim 3, wherein the test pattern image is output from a computer to the display device, and the distortion factor and compensation factor is calculated by the computer.

5. The method of adjusting image distortion as claimed in claim 3, wherein the compensation factor is stored in a compensation processor of the display device.

6. The method of adjusting image distortion as claimed in claim 5, wherein the image signal is input into the compensation processor, and the compensation factor is applied to the image signal.

7. The method of adjusting image distortion as claimed in claim 3, wherein the distorted pattern image appearing on the screen of the display device is captured by an image-capturing device.

8. The method of adjusting image distortion as claimed in claim 6, wherein the distorted pattern image appearing on the screen of the display device is captured by an image-capturing device.
